(19) United States
(12) Patent Application Publication
(10) Pub. No.: US 2008/0067720 A1
(43) Pub. Date: Mar. 20, 2008

(54) Open-Cell Polyurethane Foam Without Skin Formation, Formulation for Its Preparation and Its Use as Support Material for Cell Cultures and Tissue Cultures or Medicaments

(76) Inventors: Hinrich Wiese, Landsberg am Lech (DE); Gerhard Maier, Munchen (DE)

Correspondence Address: MCDONNELL BOEHNEN HULBERT & BERGHOFF LLP, 300 S. WACKER DRIVE, 32ND FLOOR, CHICAGO, IL, 60606, US

(21) Appl. No.: 11/575,848

(22) PCT Filed: Sep. 22, 2005
(86) PCT No.: PCT/EP05/10266

§ 371 Date: Oct. 16, 2007

Related U.S. Application Data
(60) Provisional application No. 60/496,019, filed on Aug. 19, 2003.

(51) Int. Cl. C08G 18/00; B29C 39/36

(52) U.S. Cl. 264/334; 521/158

(57) ABSTRACT

The present invention relates to a formulation for the preparation of a biocompatible, optionally biodegradable open-cell polyurethane foam having open pores also at its surface without a mechanical post-treatment, i.e., having no skin, such a polyurethane foam as well as a method for the preparation thereof and the use thereof. The present invention further relates to a method for the preparation of a scaffold for cell cultures, tissue cultures as well as for tissue engineering which uses the formulation for the manufacture of the open-cell polyurethane foam, as well as a scaffold obtained by this method.

The present invention relates to a formulation for the preparation of a biocompatible, optionally biodegradable open-cell polyurethane foam having open pores also at its surface without mechanical post treatment, which does not have a skin. The present invention further relates to such a polyurethane foam as well as to a method for its preparation and its use. The size of the pores of the polyurethane foam obtained by heating the formulation as well as the number of pores being open to the exterior of the foam increase in those areas, which are close to the surface of the foam. This enables the use of the polyurethane foam according to the present invention for the manufacture of a scaffold (cell support) for cell cultures, tissue cultures and for tissue engineering. Furthermore, the present invention relates to a method for preparing a scaffold for cell cultures, tissue cultures and for tissue engineering, which uses the formulation for pre-paring an open-cell polyurethane foam, as well as a scaffold for cell cultures, tissue cultures and for tissue engineering, which has been obtained by the method according to the present invention.

Foamed polymers are used in various fields. They are more lightweight than compact materials and in addition they exhibit various further advantages. Polymeric foams are categorized with respect to the base material and whether the pores are interconnected (open-cell foam or sponge) or whether they are separated by variably compact walls (closed-cell foam).

Open-cell polyurethane foams or sponges are employed in various fields from cleaning sponges and filter materials to scaffolds (plastic frameworks as support for cells) for tissue engineering. The economic importance of such sponges is very high because very large amounts are required in some fields such as the automobile industry and high-value materials are used in other fields such as medical technology. Therefore, the field of producing polymeric foams and improvements thereof are a permanent subject of intensive research work.

There are different methods for producing polyurethanes in the form of foams or sponges (A. J. DeVries, Rubber Chem. Technol. 1958, 31, 1142):
by inert gases dissolved under pressure;
by evaporating volatile inert liquids;
by compounds which decompose into gases at an increased temperatures (reversibly such as alkali metal carbonates and alkaline earth metal carbonates or irreversibly such as azo compounds and diazo compounds);
by water which reacts with isocyanates to form CO₂;
by fillers which are dissolved out after curing (e.g. water-soluble salts);
by solution polymerization under phase separation (the solvent dissolves the starting materials, but not the polymer; F. D. Hileman, R. E. Sievers, G. G. Hess, W. D. Ross, Anal. Chem. 1973, 45, 1126-1130);
by mechanically admixing gases (air), for example by stirring.

Thereby the open-porosity or open-cell character can be supported by additives, in particular, by surfactants (cf. Mattesky in U.S. Pat. No. 6,391,933). In the case of physical foaming agents nucleating agents are additionally required or at least advantageous in order to obtain uniformly sized and uniformly distributed pores.

The production of polymeric foams can be carried out either by foaming the already preformed polymer or from monomers by a simultaneous polymerization and foam formation. In each of these cases the basis of the foam formation is that a propellant is added into a liquid preparation which exemplarily consists of a polymer melt, a polymer solution, a polymer dispersion or a monomer mixture of one or more components, the propellant being gaseous under foaming conditions. The foam formation is initiated by increasing the concentration of the gaseous propellant in the liquid preparation beyond its saturation concentration. This can, for example, be carried out by increasing the temperature or reducing the pressure, but also by producing a sufficient amount of propellant (gas) by initiating a chemical reaction. The latter case is often employed in the production of polyurethane foams. If the gas concentration exceeds the saturation concentration, formation of bubbles occurs in an initial phase if nucleation agents are present. A satisfactory result can often be achieved also without nucleating agents because, already by mixing the components, a sufficient amount of microbubbles is present in most cases, in particular, in case of systems which polymerize and foam simultaneously. In the second phase of the foam formation the bubbles grow, whereby the large bubbles grow due to the pressure difference in bubbles having different sizes on account of the small ones. In this phase, foaming rate, surface tension and viscosity or change in viscosity of the polymer have to be adjusted exactly in order to achieve that the bubbles are maintained and the propellant does not escape preliminarily. This would result in collapsing the foam. In the next phase the solidification of the polymer is effected for example by polymerization, crosslinking or cooling such that the foam reaches its final dimensions. Depending on the interior pressure of the bubbles (pores or cells) and the mechanical properties of the polymer changes of the microscopic dimensions of the foam can occur in this phase.

During the growth of the individual bubbles the thickness of the liquid films or polymeric films between the individual bubbles is reduced more and more because the total volume of the foam grows strongly. The majority of the material is located in the edges connecting the interstices between the individual bubbles. If frequent cracks of the thin films between the bubbles occur in this phase, the propellant can escape preliminarily and the foam collapses or large spaces are formed in an uncontrolled manner. If the bubbles are predominantly maintained until the polymer solidifies, a foam having closed pores is formed. In this case the propellant is located in the pores and gets lost over a shorter or longer period via diffusion and is replaced by air. Such foams are preferably suitable for acoustic insulation and heat insulation, for example.

In contrast, open-cell foams are characterized in that the predominant number of bubbles are open towards at least two adjacent bubbles, i.e., the polymer film between the bubbles is torn or not present anymore. This enables a free exchange of gases or liquids between the pores. Such materials are suitable preferably as filter or absorption materials, but also as a scaffold for tissue engineering (tissue regeneration) in medical applications.

It has been observed for polyurethane foams (J. H. Saunders, Fundamentals of Foam Formation, in D. Klempner, K. C. Frisch, Handbook of Polymeric Foams and Foam Technology, Hanser, Munich 1991, p. 12) that open-cell foams are formed particularly in that a significant increase in the gas formation rate, i.e., in the amount of the propellant, occurs towards the end of the growth of the bubbles, shortly before the polymer becomes solidified, which make the bubbles burst. For that purpose, the polymer has to be already solidified to such an extent that the edges between the interstices between the individual bubbles are stable enough to maintain the exterior form of the foam body. It could be shown that this occurs exactly when the interior temperature of the foam increases to 100° C. due to the reaction heat of the proceeding chemical reaction. Thereby, water evaporates from the original monomer mixture and water vapour is available as an additional amount of gas. About 20% of water vapour has actually been found in the gas mixture in the pores of such foams.

Closed-cell, but also open-cell foams always have a “skin” towards their exterior (foaming mould, atmosphere and the like), i.e., a surface having no pores or few pores only. In the case of so called integral foams, this is specifically adjusted and used to achieve a mechanically stable, tight exterior skin and simultaneously as low a density as possible as well as a high porosity in the interior.

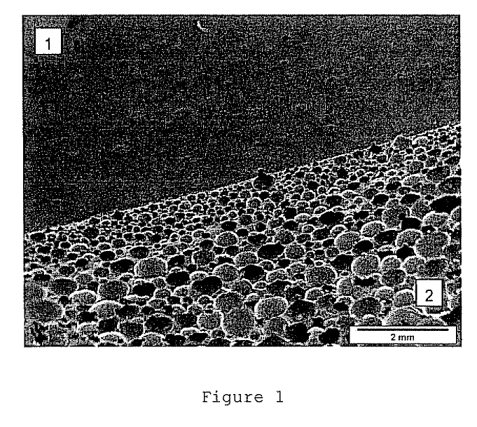

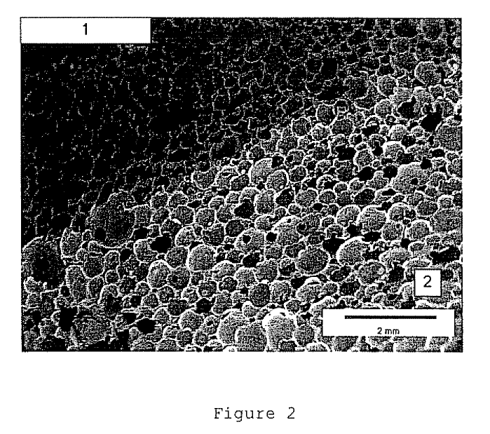

The formation of the skin is observed both upon free foaming and upon foaming in a closed mould. An example for such a skin in case of an open-cell foam can be seen for example in US 2002/0062097, FIGS. 1 and 2. Several possibilities are discussed as reasons for the skin formation: the formation of a pressure gradient, the surface tension of the foam and the formation of a temperature gradient between the foam and the mould or the tool.

A pressure gradient occurs because the propellant can not escape through the walls of the foaming mould or the tool. Consequently, a higher pressure is built up near the wall as compared to the interior of the foam. The increasing viscosity of the material during the foam formation inhibits a simple pressure equalization. Since the pore size depends on the pressure, the pores become smaller towards the wall and, finally, the skin is formed because no propellant can escape directly at the walls of the mould or the tool. Moreover, the surface tension of the polymer leads to the result that each propellant bubble or pore to be opened requires energy, because opening the pore increases the surface of the polymer and the energy required therefor has to be supplied. These effects are intensified by the formation of a temperature gradient particularly in the case of polyurethane foams and chemically related foams.

Open porosity of polyurethane foams is technically achieved for example by an additional supply of gas which is suddenly formed in the form of water vapour during the foaming process in the interior of the foam when the interior temperature reaches 100° C. This makes the gas bubbles or pores burst. However, if the wall of the mould or tool or the environment of the foam is cooler during the free formation of the foam, the “propellant impact” required to open the pores does not occur near the wall or near the surface. As a result, the pores which are located near the wall or the surface, are not opened and, thus, also the surface remains closed (R. Brathun, P. Zingsheim, PVC Foams, in D. Klempner, K. C. Frisch, Handbook of Polymeric Foams and Foam Technology. Hanser, Munich 1991, p. 246/47).

However, for particular applications, for example as filter media, sponges or also as a biocompatible scaffold for applications in the field of tissue engineering, it is required that also the skin is open-celled and, thus, that there is an unhindered access from the exterior to the interior open (i.e., interconnected) pores.

For many applications it is possible without any problem that this skin is mechanically removed, for example by trimming prefoamed semi-finished products whereby the outer parts with the skin are simply cut off which leads to a loss of material. However, in the case of more complex geometries of the foamed parts, this operation requires very large efforts. A possibility for solving this problem is to reduce the pressure or even to apply a negative pressure at a particular point in time during the foaming process after injecting the reactive composition into the mould (Cavender, K. D., J, Cell. Plast. 1.986, 22, 222-234 and Cavender, K. D., in U.S. Pat. No. 4,579,700, Union Carbide Corp., USA, 1986). However, this method cannot be applied in each case (e.g. depending on the dimensioning of the mould) and in most cases the method additionally leads to relatively large oriented pores and not simply to a continuous sequence of pores to the tool walls without the formation of a skin.

The use of an inert filler (e.g. a salt) in addition to the generation of pores by gas and its subsequent dissolving as it is occasionally applied for foams to be used as a scaffold for tissue engineering, equally results in some pores penetrating the skin, namely in those positions where the inert filler has been present at the surface and has been dissolved out subsequently. However, this requires a further step of the method and, in addition, this may result in undesired residues of the filler remaining in the polymer which is accompanied by significant drawbacks, particularly for medical applications such as tissue engineering.

Tissue engineering is a technical field of applications for new materials which has a huge growth potential: In the case of tissue defects and organ defects due to trauma, disease or hereditary abnormalism, conventional therapies such as implantation of prostates (natural prostates such as bones or tissue from donators or artificially manufactured prostates such as metallic implants, plastic implants) reach their limits more and more (infections, rejection reactions of the tissue). Furthermore, the conventional implantation of prostates in the region of the connective tissue is frequently characterized by a limited functional capability and durability of the artificial materials [C. W. Patrick, A. G. Mikos, L. V. McIntire (Ed.) Frontiers of Tissue Engineering, Elsevier Science Ltd. Oxford 1998]. Therefore, modern medicine desires to produce autologous implants (implants consisting of the patient's own cells or tissue on scaffolds made of biocompatible resorbable materials such as synthetic polymers). In this regard, one of the most promising approaches since the beginning of the 90s is tissue engineering by growing cells resulting from an autodonation of the recipient on a porous polymer framework which is subsequently degraded biologically to form harmless products. This method aims at functional replacement tissues whose form fits exactly to the implantation site or to the defect to be cured and which is not rejected by the recipient because it is formed from the recipient's own cells. In addition to various polymers whose mechanical properties significantly differ from those of the tissue to be formed (polylactide, polyglycolide, alginates, fibrin adhesive), particularly polyurethanes may be considered. Polyurethanes exhibit the advantage that their mechanical properties can be modified over a wide range which also embraces those of many of the body's own tissues (e.g. cartilage, veins and tendons). The degradation rate of the polyurethanes may be adjusted via their components [N. M. K. Lamba, K. A. Woodhouse, S. L. Cooper, Polyurethanes in Biomedical Applications, CRC Press, Boca Raton, Boston, London, New York, Washington, 1998].

Therefore, it is the object underlying the present invention to provide a formulation or a composition for producing an open-cell polyurethane foam having also at its surface a plurality of open pores, i.e., having no skin, and which overcomes the above-described problems occurring in the art. In particular, the polyurethane foam resulting from the formulation shall be biocompatible and the number and size of the pores shall at least be distributed uniformly throughout the polyurethane foam or preferably increase in those areas of the foam which are close to the surface, thereby rendering the polyurethane foam suitable for cell cultures, tissue cultures and for tissue engineering.

During testing additives for polyurethane formulations for tissue engineering it has now surprisingly found that the use of particular monosaccharides, disaccharides, oligosaccharides and polysaccharides in such formulations in small amounts leads to a significant improvement of the porosity and of the open-porosity. Accordingly, as an example, the foams produced according to the present invention can easily be filled with the cell culture media described above. The number and size of the pores increases in the regions of the foam which are located close to its surface. This result could be achieved both in closed silicone casting moulds as well as by free casting processes (e.g. in Petri dishes or beakers).

Thus, the object underlying the present invention is solved by the formulation for preparing an open-cell polyurethane foam described in the claims, by the open-cell polyurethane foam described in the claims, by the method for pre-paring such a polyurethane foam described in the claims, by the use of such a polyurethane foam described in the claims, by the method for preparing a scaffold described in the claims and by the scaffold described in the claims.

According to the present invention, the object underlying the present invention is accordingly solved by a formulation for preparing an open-cell polyurethane foam comprising a polyol component (a) containing at least one hydroxyl group containing compound, a polyisocyanate component (b) containing at least one isocyanate group containing compound and a saccharide component (c) containing at least one monosaccharide, disaccharide, oligosaccharide or polysaccharide.

The saccharide component (c) is preferably contained in the formulation according to the present invention in an amount of 0.01 to 4.20% by weight, particularly in an amount of 0.5 to 3.70% by weight and particularly preferred in an amount of 0.7 to 3% by weight, wherein the amount of the saccharide component (c), based on the amount of the polyol component (a) (i.e., the total mass of the formulation minus the polyisocyanate component (b)) amounts to less than 5% by weight, preferably 0.3 to 4.5% by weight and, in particular, 0.5 to 4.0% by weight.

According to the present invention, preferred saccharide components are monosaccharides such as dextrose, mannose, mannitol, dulcitol, glucose, fructose, galactose and the like, disaccharides such as maltose, lactose, saccharose, cellobiose and the like, oligosaccharides and polysaccharides such as cellulose, pectin, amylopectin and the like, whereas starch is excluded, as well as mixtures of two or more thereof, monosaccharides being particularly preferred. Particularly preferred monosaccharides are hexitols such as dextrose, mannitol and dulcitol.

Saccharides as constituents of biocompatible polyurethanes are generally known. For example, S. Wilbullucksanakul, K. Hashimoto, M. Okada, MakRromol. Chem.& Phys. 1996, 197, 135-146 describe the use of D-glucaro-1,4:6,3-dilactone und D-mannaro-1,4:6,3-dilactone; U. Klügel, in DE 4430586, AUF Analytik Umwelttechnik, Germany, 1996 describes the use of polysaccharide-containing microbial biomass. Therein, the saccharides are typically used as monomers in high proportions. However, an influence of the saccharides on the open-porosity of the resulting polyurethanes has not yet been described. According to the present invention, this open-porosity is achieved by the use of saccharides in relatively small amounts, as described above.

A formulation according to the present invention contains as a polyol component (a) a compound containing at least two hydroxyl groups or mixtures of such compounds. These compounds are preferably hydroxyl-terminated polyethers such as α,ω-dihydroxy poly(oxyethylenes), α,ω-dihydroxy poly(1,2-ethylene oxide), α,ω-dihydroxy poly(1-2-propylene oxide) α,ω-dihydroxy poly(1,3-trimethylene oxide), α,ω-dihydroxy poly(1,4-tetramethylene oxide), α,ω-dihydroxy poly(methyleneoxy-1,2-ethylene oxide) and the like as well as copolymers thereof having molecular weights of preferably up to 15000 g/mol, hydroxyl-terminated aliphatic polycarbonates such as α,ω-dihydroxy polyethylene carbonate), α,ω-dihydroxy poly(1,2-propylene carbonate), α,ω-dihydroxy poly(1,3-propylene carbonate) α,ω-dihydroxy poly(tetramethylene carbonate), α,ω-dihydroxy poly(hexamethylene carbonate) and the like as well as copolymers thereof, each having a molecular weight of preferably up to 15,000 g/mol, polyanhydrides of dicarboxylic acids such as malonic acid, succinic acid, glutaric acid and the like as well as copolymers thereof, each having molecular weights of preferably up to 15,000 g/mol, bivalent or polyvalent low molecular weight alcohols such as glycol, 1,2-propylene glycol, 1,3-propylene glycol, butanediol, pentanediol, hexanediol and long-chained linear or branched-chained aliphatic diols, glycerine, triethanolamine, pentaerythritol, 2,2-bis(hydroxymethyl)propanol and the like, hydroxyl group containing amino acid dimers, trimers or oligomers, e.g. those of tyrosine and/or serine, as well as sugar alcohols such as sorbitol and other natural products or derivatives thereof having at least two hydroxyl groups and the like.

More preferably, polyesters having hydroxyl groups as terminals, are used as the polyol component (a). Examples for such compounds are polycaprolactone diol having a number average molecular weight of up to 15,000 g/mol, particularly preferred 200 g/mol to 5,000 g/mol; and polycaprolactone triol having a number average molecular weight of up to 15,000 g/mol, particularly preferred 200 g/mol to 5,000 g/mol (e.g. commercially available under the trade name Capa from Solvay as well as from fine chemical distributors). Further examples are α,ω-dihydroxy poly(D,L-lactide), α,ω-dihydroxy poly(D-lactide), α,ω-dihydroxy poly(L-lactide), α,ω-dihydroxy poly(glycolide), α,ω-dihydroxy poly(hydroxybutyrate) and other aliphatic polyesters as well as copolymers thereof including segmented block copolymers of polyether segments and polyester segments such as those obtainable by reacting high molecular weight polyesters with hydroxyl group terminated poly(alkylene glycols), as well as mixtures of such polyols.

The polyol component (a) is contained in the formulation according to the present invention in an amount of 15 to 85% by weight, more preferably in an amount of 30 to 80% by weight and particularly in an amount of 45 to 75% by weight.

According to the present invention, a compound containing at least two isocyanate groups or mixtures of such compounds is used as the polyisocyanate compound (b). A preferable compound is selected from the following: optionally substituted alkylene diisocyanates having 3 to 12 carbon atoms such as hexamethylene diisocyanate or lysine diisocyanate, optionally substituted cycloalkylene diisocyanates having 5 to 15 carbon atoms such as cyclohexylene diisocyanate, optionally substituted alkylcycloalkylene diisocyanates having 6 to 18 carbon atoms such as isophorone diisocyanate, optionally substituted aromatic diisocyanates such as p-phenylene diisocyanate, toluene diisocyanates (all isomers including their mixtures), 4,4′-diphenylmethane diisocyanate as well as isomers, trimers and higher oligomers of these diisocyanates, uretdiones of these isocyanates, cyanurates and isocyanurates of these isocyanates and the like. A particularly preferably used compound is isophorone diisocyanate.

The polyisocyanate component (b) is used in the formulation according to the present invention in an amount of 8 to 70% by weight, more preferably in an amount of 12 to 50% by weight and particularly in an amount of 17 to 36% by weight.

Furthermore, the formulation for preparing an open-cell polyurethane foam according to the present invention may comprise a catalyst component (d), which catalyzes the reaction between hydroxyl groups and isocyanate groups, as well as a propellant component (e) which is gaseous at the foaming temperature or forms a gas at the foaming temperature.

As catalysts (d) basic compounds or Lewis acidic compounds can be used in the formulation according to the present inventions. Examples for basic catalysts are diazabicycloundecene (DBU) and similar cyclic or polycyclic amines, morpholine derivatives such as N-alkylmorpholines, DMDEE, DMDLS and similar polyfunctional amines, ethanolamines and other basic catalysts for the preparation of polyurethanes and polyureas known to the person skilled in the art. Examples for Lewis acidic catalysts are metal complexes such as dibutyltin dilaureate, iron, zirconium or vanadium acetylacetonate, titantetraisopropylate and other suitable Lewis acidic compounds for this purpose known to the person skilled in the art. DBU is particularly preferred as the catalyst.

The catalyst (d) is generally used in the formulation according to the present invention in an amount of 0.01 to 5% by weight, preferably 0.1 to 1% by weight and more preferably 0.2 to 0.7% by weight.

The formulations according to the present invention can also contain a propellant component (e) for the foam formation Suitable propellants for this purpose are water or organic solvents or combinations thereof. Propellant and processing temperature have to be adapted such that the propellant forms a gas during processing into a foam by evaporation (e.g. solvent) or by chemical reaction (e.g. water). Thus, optionally substituted straight-chained, branched-chained and cyclic alkanes such as pentane, hexane, heptane, isooctane, cyclohexane and the like, acetals such as methylal (dimethoxymethane) und 1,1-dimethoxyethane, ketone such as acetone, esters such as ethylacetate, halogenated hydrocarbons such as chloroform, dichloromethane and dichloroethane either alone or in mixtures are preferred as physical propellants or in combination with water as a chemical propellant. Acetals such as methylal (dimethoxymethane) and 1,1-dimethoxyethane are particularly preferred. Also solids which release gases at the reaction temperature, i.e., temperatures below 100° C., may also serve as propellants. Inorganic compounds such as ammonium salts, preferably ammonium carbonate, ammonium bicarbonate and ammonium oxalate or organic compounds such as carbazides, hydrazides (e.g. benzene sulfohydrazide), azo compounds and diazo compounds may be mentioned as examples. The solids or solutions thereof may be used either alone or as a mixture with at least one physical and/or chemical propellant.

According to the present invention the physical propellants are used in amounts of 7 to 30% by weight, the solid propellants are used in amounts of 1 to 5% by weight and water is used in amounts of 0.01 to 1% by weight.

The formulation according to the present invention may further contain one or more additional additives which are known to the person skilled in the art. Examples for such additives are diluents, plasticizers, surfactants, foam stabilizers, nucleating agents, compounds for adjusting the surface tension and the polarity, viscosity modifiers and the like. Examples for such additives capable of achieving such functions in these formulations, are amphiphilic polymers (e.g. pluronics, PEO/PPO copolymers or block copolymers, partially sapontied poly(vinylacetate)), silicone oils, inorganic particles such as particles of tricalcium phosphate, hydroxy apatite and the like, sodium chloride and other salts as well as amino acids and the like.

For the formation of the polyurethane foam the formulation according to the present invention is premixed at a temperature of 20° C. to 70° C. Preferably the polyol component (a) and the saccharide component (c) are mixed first and the polyisocyanate component (b) is subsequently added. Then the formulation is filled into a suitable form and heated to a temperature sufficient to initiate the polymerization reaction. Usually the temperature is within a range of 30° C. to 90° C. Subsequently, the polyurethane foam is maintained at this temperature until it is completely cured, which usually requires about 1 minute to 24 hours. Then the mould can be removed. Finally, the hydrophilicity of the polyurethane foam may be improved by an additional treatment in alcohols, water or aqueous solutions such as culture media for cell cultures, optionally with a gradual transition, at room temperature or elevated temperature. Usually this treatment is carried out in one or more steps over a period of about 1 minutes to 24 hours.

The pore structure and the interconnectivity of the pores of the polyurethane foam can be additionally improved by applying a negative pressure at the end of the foaming process.

The present invention describes a general solution alternative for inhibiting the formation of a skin which is particularly suitable for the production of biocompatible and biodegradable polyurethane foams for medical applications such as tissue engineering.

Since the polyurethane foams according to the present invention are non-toxic and biocompatible, can be sterilised by conventional methods and have a good hydrophilicity which is of particular relevance for the adsorption of cells at the surface, the polyurethane foams according to the present invention represent an important progress particularly in the field of foams for tissue engineering.

A tissue engineering method which is particularly suitable for the foams prepared according to the present invention, involves the recording of the form of the desired implants from the patient by means of imaging methods (such as ultrasonic imaging, computed tomography). On the basis of these image data a model is produced by means of laser stereolithography and a negative mould thereof is prepared from a suitable material such as silicone. Using this negative mould, the scaffold (the cell support) can be formed by a simple casting method as an open-cell foam without skin made of physiologically degradable and biocompatible polyurethane. This scaffold has exactly the form which corresponds to the position, into which the implant is to be implanted into the patient. The scaffold is filled with cells (directly as a suspension or embedded into a gel (e.g. fibrin adhesive) which may also contain cytobiological messengers such as growth factors etc.). This filling process is possible with a completely open-cell foam having no skin only. Implants being prepared by this method can be used particularly as replacement for cartilage, e.g. in the field of the ears, the nose, the intervertebral discs, the meniscus as well as in situations in which cartilage-bone-connections are required such as for example in articular cartilages (e.g. knee) and the like.

In the following the present invention is further illustrated by reference to the accompanying drawings. Thereby, the examples given serve to illustrate the invention and should not be construed as limiting the invention.

FIG. 1 shows a scanning electron micrograph (SEM micrograph) of a polyurethane foam according to the state of the art which has been obtained in Comparative Example 1, whereas

FIG. 2 shows an SEM micrograph of the polyurethane foam obtained in Example 1 from a formulation according to the pre-sent invention.

In the FIG. 1 denotes the surface of the respective polyurethane foam and 2 denotes a section into the interior of the respective polyurethane foam.

### EXAMPLES

As is known to the person skilled in the art, the open-porosity of polyurethane foams can be influenced both by additives and by processing operations. Each of the following Examples (except for Comparative Example 1) represents open-cell foams and show how the open-porosity at the surface of the formed article or at the walls of a silicone mould can be achieved. All percentages in the examples refer to the weight.

### Comparative Example 1

A formulation of 24% polycaprolactone diol (Mₙ=1,250), 20% polycaprolactone triol (Mₙ=900), 36% isophorone diisocyanate, 1.6% polyethylene glycol-block-polypropylene glycol-block-polyethylene glycol (Mₙ=14,600), 4% triethanolamine, 0.08% water, 2.5% cellulose acetate butyrate, 0.25% diazabicycloundecene and 11.57% cyclohexane is heated to 75° C. for four hours in a Petri dish or in a silicone mould after thorough mixing at 60° C. As can clearly be seen from FIG. 1, the formulation obtained is actually open-celled, however, is towards the surface most of the pores are closed by a skin.

### Example 1

A formulation of 24% polycaprolactone diol (Mₙ=1,250), 20% polycaprolactone triol (Mₙ=900), 36% isophorone diisocyanate, 1.6% polyethylene glycol-block-polypropylene glycol-block-polyethylene glycol (Mₙ=14,600), 4% triethanolamine, 0.08% water, 2,5% dextrose (corresponding to 3.9% based on the polyol component wherein the polyol component contains all components except for the diisocyanate), 0.25% diazabicycloundecene and 11.57% cyclohexane is heated to 75° C. for four hours in a Petri dish after thorough mixing at 60° C. The resulting formed article is uniformly porous. FIG. 2 clearly shows that the interconnectivity of the pores is well developed. In contrast to the polyurethane foam of Comparative Example 1, the pores are also open at the surface in this case. The foam is put into boiling water for one hour after its preparation, thereby improving its hydrophilicity. Then it can easily be loaded for example with fibrin adhesive containing a cell culture (e.g. chondrocytes, fibroblasts or osteoblasts).

### Example 2

A formulation as described in Example 1 is cast into a silicone mould having one gate only. The silicone mould has been produced via a stereolithographic model in accordance with a human ear. The mould was preheated to 70° C. and the temperature is maintained for a hours for curing. A uniformly foamed formed article is obtained. The pores at the surface are open and interconnected to the pores in the interior. The hydrophilicity is improved by boiling in water or physiological saline also in the case of this formed article. The formed article obtained can easily be filled with a mixture of cells, fibrin adhesive and various growth factors for the preparation of an implant.

### Example 3

Example 3 shows the suitability of the biocompatible nucleating agent tricalcium phosphate in the form of nanoparticles in the formulation according to the present invention.

40% tricalcium phosphate nanoparticles as a nucleating agent is dispersed in polycaprolactone diol (Mₙ=2000). A formulation containing 14.0% of this dispersion as well as 21.3% polycaprolactone diol (Mₙ=2,000), 21.3% polycaprolactone triol (Mₙ=900), 17.7% isophorone diisocyanate, 1.8% polyethylene glycol-block-polypropylene glycol-block-polyethylene glycol (Mₙ=14,600), 2.1% triethanolamine, 0.07% water, 2.1% dextrose (corresponding to 2.559 based on the polyol component wherein the polyol component includes all components except for the diisocyanate), 1.4% octanol, 0.21% diaminobicycloundecene and 18.02% cyclohexane, is prepared. After thorough mixing at 55° C. this formulation is heated in a Petri dish to 75° C. for four hours. The resulting formed article is uniformly porous. The interconnectivity of the pores is good and the pores at the surface are open. The foam is boiled in water for an hour after its preparation, thereby improving its hydrophilicity. Then it can easily be filled for example with fibrin adhesive containing a cell culture (e.g. chondrocytes, fibroblasts or osteoblasts).

### Example 4

Applying a negative pressure at the end of the foaming process can additionally improve the pore structure and the interconnectivity of the pores.

A formulation of 51% polycaprolactone triol (Mₙ=900), 21.4% isophorone diisocyanate, 0.25% foam stabilizer DABCO 3042, 1.05% dextrose (corresponding to 1.33% based on the polyol component wherein the polyol component includes all components except for the polyisocyanate), 0.5% diazabicycloundecene and 25.8% hexane is heated for four hours to 67° C. in a Petri dish after thoroughly mixing at 55° C. The resulting formed article is uniformly porous. Then the foam is evacuated to 500 mbar for 48 hours in a desiccator. In order to improve the hydrophilicity, the foam is treated for two minutes with ethanol and subsequently with modified Eagle's medium (cell culture medium). Then it can easily be loaded with fibrin adhesive containing a cell culture (e.g. chondrocytes, fibroblasts or osteoblasts).

### Example 0.5

A formulation of 25.1% polycaprolactone triol (Mₙ=900), 50.2% polycaprolactone diol (CAPA 2402, Mₙ=4,000), 15.25% isophorone diisocyanate, 0.25% foam stabilizer DABCO 3042, 1.05% dextrose (corresponding to 1.24% based on the polyol component, wherein the polyol component includes all components except for the diisocyanate), 0.5% diazabicycloundecene and 7.65% hexane is heated to 67° C. for four hours in a Petri dish after thoroughly mixing at 58° C. The resulting formed article is uniformly porous. The foam is evacuated to 500 mbar in a desiccator for 48 hours. In order to improve the hydrophilicity, the foam is treated with ethanol for two minutes and subsequently with modified Eagle's medium. Then it can easily be loaded for example with fibrin adhesive containing a cell culture (e.g. chondrocytes, fibroblasts or osteoblasts).

### Example 6

A formulation of 33.1% polycaprolactone triol (Mₙ=900), 33.1% polycaprolactone diol (Mₙ=2,000), 4.15% polyethylene glycol (PEG; Mₙ=600); 18.75% isophorone diisocyanate, 0.3% foam stabilizer DABCO 3042, 1.3% dextrose (corresponding to 1.6% based on the polyol component, wherein the polyol component includes all components except for the diisocyanate), 0.65% diazabicycloundecene and 8.65% hexane is heated to 67° C. for four hours in a Petri dish after thorough mixing at 58° C. The resulting formed article is uniformly porous. The foam is evacuated to 500 mbar for 48 hours in a desiccator. In order to improve the hydrophilicity, the foam is treated with ethanol for two minutes and subsequently with modified Eagle's medium. Then it can easily be loaded for example with fibrin adhesive containing a cell culture (e.g. chondrocytes, fibroblasts or osteoblasts).

### Example 7

After thorough mixing in a Petri dish at 30° C., a formulation of 31.19% polycaprolactone triol (Mₙ=900), 31.19% polycaprolactone diol (Mₙ=2,000), 16.81% isophorone diisocyanate, 1.14% dextrose (corresponding to 1.37% based on the polyol component, wherein the polyol component includes all components except for the diisocyanate), 0.31% foam stabilizer DABCO 3042, 18.71% methylal and 0.65% diazabicycloundecene is filled into a silicone mould (in the form of the cartilaginous portion of a human auricle) preheated to 67° C. using a syringe and maintained at 67° C. for three hours. The resulting formed article is uniformly porous, the pores are interconnected and the pores at the surface are open. No observable skin was formed during the foam formation. The formed article is evacuated to 3 mbar for 24 hours in a desiccator. In order to improve the hydrophilicity, the foam is treated with ethanol for five minutes and subsequently washed several times in Dulbeco's modified Eagle's medium. It is colonized with human chondrocytes and a continuous cartilaginous tissue is formed during culturing for four weeks.

### Example 8

After thorough mixing in a Petri dish at 30° C., a formulation of 33.7% polycaprolactone triol (Mₙ=900), 33.7% polycaprolactone diol (Mₙ=2,000), 18.0% isophorone diisocyanate, 0.7% mannitol (corresponding to 0.85% based on the polyol component, wherein the polyol component includes all components except for the diisocyanate), 0.3% foam stabilizer DABCO 3042, 13.2% methylal and 0.4% diazabicycloundecene is filled into a silicone mould (in the form of the cartilaginous portion of a human auricle) preheated to 67° C. using a syringe and maintained at 67° C. for three hours. The resulting formed article is uniformly porous, the pores are interconnected and the pores at the surface are open. No observable skin was formed during the foaming process. The formed article is evacuated to 3 mbar for 24 hours in a desiccator. In order to improve the hydrophilicity, it is treated with ethanol for five minutes and subsequently washed several times in Dulbeco's modified Eagle's medium. The formulation can also be sterilized at 134° C. using water vapour without showing any changes.

1. Formulation for the preparation of an open-cell polyurethane foam having no skin at the exterior comprising
(a) a polyol component containing at least one hydroxyl group containing compound in an amount of 15 to 85% by weight.
(b) a polyisocyanate component containing at least one isocyanate group containing compound in an amount of 8 to 70% by weight and
(c) a saccharide component containing at least one monosaccharide, disaccharide, oligosaccharide or polysaccharide provided that starch is excluded, in an amount of 0.01 to 4.20% by weight wherein the amount of the saccharide component based on the polyol component (a), amounts to less than 5% by weight.

2. Formulation for the preparation of an open-cell polyurethane foam according to claim 1, wherein the saccharide component (c) includes at least one monosaccharide, disaccharide, oligosaccharide or polysaccharide selected from the group comprising dextrose, mannose, mannitol, dulcitol, glucose, fructose, galactose, maltose, lactose, saccharose, cellobiose, cellulose, pectin, amylopectin and mixtures of two or more thereof.

3. Formulation for the preparation of an open-cell polyurethane foam according to claim 1, wherein the saccharide component (c) is contained in an amount of 0.5 to 3.70% by weight.

4. Formulation for the preparation of an open-cell polyurethane foam according to claim 1, wherein the saccharide component (c) is contained in an amount of 0.7 to 3% by weight.

5-7. (canceled)

8. Formulation for the preparation of an open-cell polyurethane foam according claim 1, wherein the polyol component (a) is contained in an amount of 30 to 80% by weight.

9. Formulation for the preparation of an open-cell polyurethane foam according to claim 8, wherein the polyol component (a) is contained in an amount of 45 to 75% by weight.

10. Formulation for the preparation of an open-cell polyurethane foam according to claim 1, wherein the polyisocyanate component (b) contains at least one isocyanate group containing compound selected from the group comprising optionally substituted alkylene diisocyanates having 3 to 12 carbon atoms, optionally substituted cycloalkylene diisocyanates having 5 to 15 carbon atoms, optionally substituted alkylcycloalkylene diisocyanates having 6 to 18 carbon atoms, optionally substituted aromatic diisocyanates, isomers, trimers and higher oligomers of these diisocyanates, uretdiones of these isocyanates, cyanurates and isocyanurates of these isocyanates and mixtures of two or more thereof.

11. (canceled)

12. Formulation for the preparation of an open-cell polyurethane foam according to claim 1, wherein the polyisocyanate component (b) is contained in an amount of 12 to 50% by weight.

13. Formulation for the preparation of an open-cell polyurethane foam according to claim 12, wherein the polyisocyanate component (b) is contained in an amount of 17 to 36% by weight.

14. Formulation for the preparation of an open-cell polyurethane foam according to claim 13, wherein the formulation further comprises
(d) a catalyst component containing a basic compound or a Lewis acidic compound and/or
(e) a propellant component containing an organic solvent as a physical propellant, a solid or water as a chemical propellant or a combination thereof.

15. Formulation for the preparation of an open-cell polyurethane foam according to claim 14, wherein the catalyst component (d) is contained in an amount of 0.01 to 5% by weight.

16. Formulation for the preparation of an open-cell polyurethane foam according to claim 15, wherein the catalyst component (d) is contained in an amount of 0.1 to 1% by weight.

17. Formulation for the preparation of an open-cell polyurethane foam according to claim 14, wherein the organic solvent of the propellant component (e) is selected from the group comprising optionally substituted straight-chained, branched-chained and cyclic alkanes, acetals, ketones, esters, halogenated hydrocarbons or mixtures thereof.

18. (canceled)

19. Formulation for the preparation of an open-cell polyurethane foam according to claim 14, wherein the solid of the propellant component (e) is an inorganic or organic compound selected from the group comprising ammonium carbonate, ammonium bicarbonate, ammonium oxalate, carbazides, hydrazides, azo compounds and diazo compounds.

20. Formulation for the preparation of an open-cell polyurethane foam according to claim 14, wherein the organic solvent of the propellant component (e) is contained in an amount of 7 to 30% by weight, the solid propellant is contained in an amount of 1 to 5% by weight and the water of the propellant component is contained in an amount of 0.01 to 1% by weight.

21. (canceled)

22. Open-cell polyurethane foam prepared by a process comprising heating a formulation according to claim 1 to a temperature of about 30° C. to about 90° C. for a period of about 1 minute to about 24 hours.

23. (canceled)

24. Open-cell polyurethane foam according to claim 22, wherein the hydrophilicity of the polyurethane foam has been further increased by boiling in water for a period of about 1 min to about 24 h and/or has been adjusted by treating with alcohol, water or culture medium in a gradual transition.

25. Method for the preparation of an open-cell polyurethane foam according to claim 22, wherein the components of the formulation according to any one of claims 1 to 21 are mixed and the mixture is heated for a period of about 3 min to about 24 h to a temperature of about 30° C. to about 90° C.

26. Method according to claim 25, wherein the polyurethane foam is further boiled in water for a period of 1 min to 24 h.

27. Method according to claim 25, wherein the polyurethane foam has been further treated with alcohol, water or culture medium in a gradual transition.

28. A sponge comprising an open-cell polyurethane foam according to claim 22.

29. (canceled)

30. A support material for a medicament comprising an open-cell polyurethane foam according to claim 22.

31. A support for a cell culture or tissue culture comprising an open-cell polyurethane.

32. (canceled)

33. A scaffold for tissue engineering comprising an open-cell polyurethane foam according to claim 22.

34-35. (canceled)

36. Method for the preparation of a scaffold for tissue engineering comprising an open-cell polyurethane foam according to claim 22, the method comprising:
(a) recording the exterior form of a desired implant by an image forming method at a patient,
(b) preparing a negative mould of said implant as a casting mould from a suitable material using the data obtained in step (a),
(c) filling the negative mould with a formulation for the preparation of an open-cell polyurethane foam according to anyone of claims 1 to 21,
(d) curing the formulation,
(e) removing the negative mould to obtain the scaffold made of an open-cell polyurethane foam and
(f) conditioning the scaffold for the colonization with cells or cell-containing support media by boiling in water or by treating with alcohols, water or culture medium in a gradual transition.

37. (canceled)

38. Scaffold prepared by a method according to claim 36.
